(19) United States
(12) Patent Application Publication
(10) Pub. No.: US 2024/0112196 A1
(43) Pub. Date: Apr. 4, 2024

(54) ISSUE TRACKING SYSTEM WITH AUTOMATED TICKET GENERATION

(71) Applicant: Atlassian Pty Ltd., Sydney (AU)

(72) Inventors: Ankesh Khemani, Bangalore (IN); Akshar Prasad, Bangalore (IN)

(73) Assignee: Atlassian Pty Ltd., Sydney (AU)

(21) Appl. No.: 17/956,732

(22) Filed: Sep. 29, 2022

(51) Int. Cl. G06Q 30/00; G06Q 50/00

(52) U.S. Cl. CPC G06Q 30/016; G06Q 50/01

(57) ABSTRACT

Methods, systems, and computer readable medium for generating ticket requests are disclosed. The method includes retrieving a content item created at a social media platform in relation to an entity being serviced by an issue tracking system and determining a help-seeking intent associated with the content item based on textual data of the content item. The method further includes determining whether the help-seeking intent associated with the content item exceeds a threshold level of intent, and upon determining that the help-seeking intent associated with the content item exceeds the threshold level of intent: generating a ticket request based on the textual data of the content item, and communicating the ticket request to the issue tracking system.

### TECHNICAL FIELD

The present disclosure generally relates to issue tracking systems and in particular to automatically detecting potential issues and generating corresponding issue tickets.

### BACKGROUND

Modern technical support and product development utilize distributed tracking systems to enable geographically distributed users to create and track issues with equipment or software. Applicant has identified many deficiencies and problems associated with existing methods, apparatuses, and systems for generating requests for tickets in such issue tracking systems. Through applied effort, ingenuity, and innovation, these identified deficiencies and problems have been solved by developing solutions that are in accordance with the embodiments of the present disclosure, many examples of which are described in detail herein.

### SUMMARY

According to a first aspect of the present disclosure a computer-implemented method is provided. The method includes retrieving a content item created at a social media platform in relation to an entity being serviced by an issue tracking system and determining a help-seeking intent associated with the content item based on textual data of the content item. The method further include determining whether the help-seeking intent associated with the content item exceeds a threshold level of intent, and upon determining that the help-seeking intent associated with the content item exceeds the threshold level of intent: generating a ticket request based on the textual data of the content item, and communicating the ticket request to the issue tracking system.

According to another aspect of the present disclosure there is provided a non-transitory computer readable medium. The non-transitory computer readable medium includes instructions, which when executed by a processing unit, cause the processing unit to perform the method of the first aspect.

According to yet another aspect of the present disclosure a computer processing system for generating a ticket request is disclosed. The system includes a processing unit and non-transitory computer readable medium including instructions which, when executed by the processing unit, cause the computer processing system to perform the method described above.

### BRIEF DESCRIPTION OF THE DRAWINGS

FIG. 1 is an example ticket generated by an ITS.

FIG. 2 is a diagram depicting a networked environment in which various features of the present disclosure may be implemented.

FIG. 3 is a diagram depicting an issue management system according to aspects of the present disclosure.

FIG. 4 is a block diagram of a computer processing system configurable to perform various features of the present disclosure.

FIG. 5 is a flowchart illustrating an example method for generating a ticket according to some aspects of the present disclosure.

FIG. 6 is a flowchart illustrating an example method for communicating messages from an issue tracking system to a social media platform using the issue management system of the present disclosure.

FIG. 7 is a flowchart illustrating an example method for communicating messages from a social media platform to an issue tracking system using the issue management system of the present disclosure.

FIG. 8 illustrates an example ticket generated by an issue tracking system in response to a ticket generation request from the issue management system of the present disclosure showing an agent comment.

FIG. 9 illustrates an example social media message showing the agent comment of FIG. 8.

FIG. 10 illustrates an example social media message showing a user comment to the agent comment of FIG. 9.

FIG. 11 illustrates the example ticket of FIG. 8 showing the user comment of FIG. 10.

FIG. 12 illustrates an example ticket generated by the ITS in response to a ticket request from the issue management system according to some embodiments of the present disclosure.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description, numerous specific details are set forth in order to provide a thorough understanding of the claimed invention. It will be apparent, however, that the claimed invention may be practiced without these specific details. In some instances, well-known structures.

Various embodiments of the present disclosure address technical problems associated with efficiently, reliably, and automatically generating issue tickets for issue tracking systems and providing mechanisms for integrating issue tracking systems with social media platforms.

In some examples, the presently disclosed systems and methods can be utilized in a collaborative software application such as an issue tracking system (ITS). Issue tracking systems are systems that manage the creation and tracking of issues or tickets in a variety of contexts. An issue is an item with associated information (e.g., a title and a brief description) and an associated workflow—for example, a series of states through which the issue transitions over its lifecycle (e.g., pending, assigned, in process, completed).

As one example, an ITS may be deployed for use by a service helpdesk—e.g., an IT service helpdesk in a large organization. A busy service helpdesk may manage thousands, tens of thousands, or even more issues. Each issue may have a different priority, require different actions, be handled by different people, and/or be handled by multiple different people over its lifecycle. An ITS may be used to assist in managing and tracking this process. When a problem is submitted to the helpdesk, an “issue” is created and assigned (at times with a particular priority). As the issue is worked on by various users, the progress of the issue is recorded and tracked by the ITS until, ideally, the issue is resolved and closed.

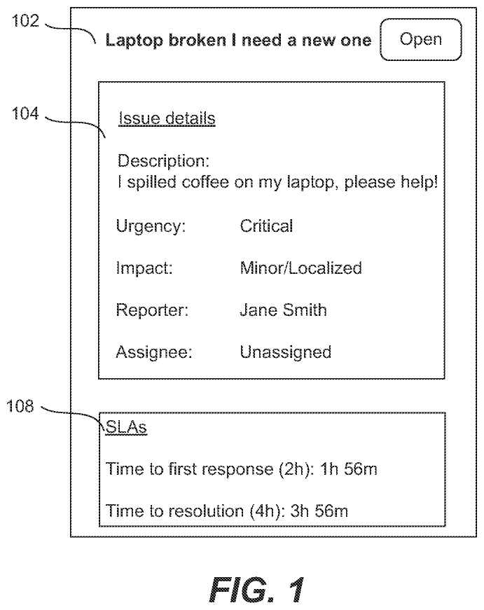

FIG. 1 illustrates an example user interface 100 displayed by an example ITS system for a particular issue. In this example, the user interface displays a title 102 of the issue (e.g., laptop broken, I need a new one) and issue details 104. The issue details 104, may include a description associated with the issue (e.g., I spilled coffee on my laptop, please help!), a person the issue is assigned to (e.g., unassigned in this example), a person that reported the issue (e.g., Jane Smith in this example), an urgency associated with the issue (e.g., critical), an impact the issue has on multiple users (e.g., minor/localized), etc. Further still, the ITS may provide an associated workflow 106 for each issue—e.g., a series of states through which the issue transitions over its lifecycle (e.g., pending, assigned, in process, completed). These workflows may be customizable. For example, instead of pending, an organization may include the states, “open,” and “unassigned” in case the issue is still active and hasn't been assigned to any person as yet respectively. Further, the ITS may assign service level agreements (SLA) 108 for the issue when it is created (e.g., based on the assigned priority and impact values) and monitor the status of the issue against these SLAs. User interface 100 shows the SLAs 108 for the issue (e.g., 2 hours to first response and 4 hours to resolution in this case).

Typically, to create such an issue, a user logs into a user account the user has with an ITS. Once the user is authenticated, the ITS displays a user interface to the user via which the user can create a new issue. In one example, the user interface may display a selectable affordance, which when selected renders and displays an issue creation screen. The issue creation screen may be in the form of an input form including multiple required and optional fields for the user to fill before the issue can be created. Example fields include, e.g., issue title, issue description, issue type, the service or application affected by the issue, etc. In some examples the user is required to input the answers manually. In other examples, the user interface provides prepopulated drop-down menus and the user may select the inputs for one or more of the fields from the drop-down menus. In any case, once the user has provided at least the required information in the issue creation screen, the user submits the issue creation request, e.g., by selecting a “SUBMIT” affordance on the user interface. Once this is done, the ITS creates an issue record based on the submitted information and stores it.

One or more helpdesk agents can be assigned to the issue after it is created and may interact with issue, e.g., to identify the issue, work on it, communicate with the user associated with the issue, and change the workflow state of the issue until the issue is resolved or completed, etc.

There may be one or more difficulties with this process. Firstly, a user has to be aware of the helpdesk and get in touch with the helpdesk to register an issue the user is facing. The user may do this by creating an issue as described above or by contacting a helpdesk agent via other means, such as email, chat, or phone, and the agent may create the issue on behalf of the user. Further, the user may have to access the ITS once the issue is created to check the progress of the issue, respond to any questions raised by the helpdesk agent, etc. This process may be appropriate where the user is aware of the helpdesk, e.g., in case the helpdesk is associated with the organization a user is employed in. However, this process may be problematic where a user has an issue with an entity such as an organization, a software application, or a product hosted by a third party. In this case, the user may have to visit the entity webpage, troll through the website to identify the help/support page, and use one of the mechanisms listed on the webpage to engage with the helpdesk agents who may be able to address the user's issues. It will be appreciated that this process can be tedious and may further frustrate the user and affect the user's impression of the entity.

To address one or more of the above-described challenges related to raising issues with conventional ITS or helpdesks, various embodiments of the present disclosure describe techniques for detecting potentially help-seeking users by monitoring social media messages associated with one or more entities, such as organizations, software applications, or products a helpdesk is associated with. As more and more users engage with social media platforms, these platforms have become the first communication means for many users. Users are increasingly more aware of social media accounts or handles of organizations, software applications, or products they consume as opposed to being aware of more traditional communication means such as company websites or support pages. Further, users increasingly turn to social media platforms to engage with the organizations, software applications, or products.

Accordingly, aspects of the present disclosure utilize this knowledge about user behaviors and monitor social media messages to identify help-seeking messages posted by users. In particular, aspects of the present disclosure disclose an issue management system that is configured to monitor social media messages generated by users in relations to organizations, software applications, or products that are relevant to an ITS or helpdesk and automatically create tickets on behalf of the corresponding social media users when the issue management system detects potential help-seeking messages and communicates these tickets to the ITS. The ITS in turn creates a record and stores the ticket.

Further, in some embodiments, in addition to generating and communicating tickets to the ITS, the issue management system may also be configured to monitor the ticket in the ITS and communicate any progress on the ticket back from the ITS to the corresponding social media platform such that the help-seeking user may be aware that a ticket has been created and view the progress of the ticket directly from the social media platform without having to leave the context of the social media platform.

By using the described techniques, various embodiments of the present disclosure generate tickets in real-time that can alert helpdesk agents to act on issues proactively, instead of the user having to contact the helpdesk first. Further, aspects of the present disclosure reduce cognitive burden on users as they do not need to take any steps to create an issue or request help. This not only increasing the efficiency and effectiveness of the ITS and helpdesk, but may also help increase customer loyalty. In doing so, various embodiments of the present disclosure make substantial technical contributions to improving the efficiency and the effectiveness of ITS systems.

### Example Systems

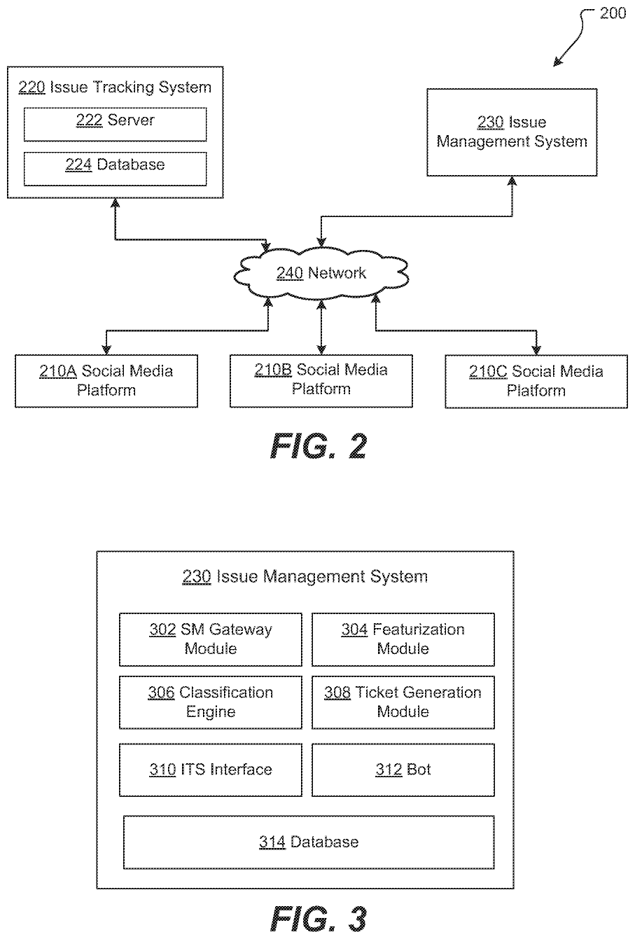

FIG. 2 depicts an exemplary environment 200 for automatically generating issues according to aspects of the present disclosure and for integrating the ITS and social media platforms once an issue has been created. The environment 200 includes one or more social media platforms 210A, 210B, and 210C (collectively referred to as social media platforms 210), an ITS 220, and an issue management system 230.

In general, social media platforms 210 are system entities that provide the means of interaction among users. Using such systems, users can create, share, and exchange information with other users in communities created in virtual environments. Examples of such platforms 210 include Internet-based applications such as Twitter®, Facebook®, Instagram®, and LinkedIn®, which allow creation and exchange of content items (including messages, posts, comments, and other interactions) through various methods.

In general, each social media platform 210 includes at least one server (not shown), at least one database (not shown), and at least one server application (not shown) running on the server. In addition, each social media platform 210 may have a client application that provides client-side functionality of the social media platform. The client applications may be installed and/or executed on users' client devices (not shown) and may work in tandem with the server application to enable users to interact with the corresponding social media platform.

The social media server applications manage interactions between users, maintain user accounts (e.g., in the one or more databases), and activity performed by the users on the social media platforms in association with their user accounts.

Social media platforms 210 also include a number of application programming interfaces (APIs) to enable third party software applications to retrieve data from or communicate data to the social media platforms.

The ITS 220 is a system entity that hosts an ITS application that is configured to create and manage issues related to one or more entities such as organizations, software applications, or products. The ITS 220 may include one or more servers (e.g., 222) for hosting the ITS application and one or more storage devices (e.g., database 224) for storing application specific data. Examples of software applications hosted by the ITS 220 include an issue tracking application (e.g., JIRA®, offered by Atlassian, Inc). It will be appreciated that Jira is just an example that the presently disclosed issue management system 230 can be used with any ITS application without departing from the scope of the present disclosure.

In order to run an ITS application, the server 222 includes one or more application programs, libraries, APIs, or other software elements that implement the features and functions of the application. The ITS 220 also stores ITS data. ITS data generally includes: data defining the operation of the ITS application (for example, user accounts, user permissions, and the like); and application data (e.g., the content hosted/maintained by the application, which can be, for example, issue data). The data is stored on and managed by database 224. Database 224 is provided by a database server which may be hosted by server 222, but is more typically hosted on a separate physical computer in communication (directly or indirectly via one or more networks) with the server 222.

The issue management system 230 is communicatively coupled between the social media platforms 210 and the ITS 220. In particular, it receives social media content from the social media platforms 210, analyses this content to determine whether the content indicates a potential issue needs to be created and generates a corresponding issue. In order to do so, the issue management system 230 includes a plurality of sub-systems or modules.

FIG. 3 is a block diagram illustrating these sub-systems or modules of the issue management system 230. In particular, as seen in FIG. 3, the issue management system 230 includes a social media (SM) gateway module 302, a featurization module 304, a classification engine 306, a ticket generation module 308, an ITS interface 310, a bot 312, and a database 314.

As noted earlier, the social media platforms 210 include one or more APIs to allow third party software applications to communicate with the social media platforms 210. The SM gateway module 302 integrates with one or more such APIs to retrieve social media content related to the one or more software applications or product associated with the ITS 220. For example, if the ITS 220 is associated with a helpdesk for product X, the gateway module may be configured to retrieve social media content related to product X.

In some examples, the SM gateway module 302 may be configured to retrieve just the social media content items—e.g., messages, posts, tweets, comments, etc. In other embodiments, the SM gateway module 302 may be configured to also retrieve associated metadata such as time logs associated with the creation of the content, information about the location of the users (e.g., creator and interactors) associated with the content, etc.

The SM gateway module 302 is also configured to generate content item descriptors based on this received information and store the content item descriptors in the database 314.

The featurization module 304 is configured to extract and process textual data from the content item descriptors. In some embodiments, the featurization module 304 may be configured to segment larger textual items (e.g., comprising 10-15 sentences) into smaller segments (e.g., comprising 2-3 sentences).

The classification engine 306 is configured to ingest input sentences and determine whether the sentences are associated with a help-seeking intent or not. As used herein, textual data having “help-seeking” intent refers to textual data that indicates that the creator of the textual data may be actively or passively seeking assistance to understand, get advice, information, solution, or general support in response to a problem. Examples of active help-seeking sentences may include, “Can somebody please help me fix my computer?” Examples of passive help-seeking sentences may include, “My laptop broke again!”. In the first example, it is clear that the user is requesting assistance. In the second example, the user is complaining and has not asked for help explicitly, but may wish to be serviced by a helpdesk.

The classification engine 306 may assess an input text and determine the probability of that sentence having a help-seeking intent. In the two example sentences described above, it may determine that the first sentence has a help-seeking intent score of 0.8 and it may determine that the second sentence also has a help-seeking intent, but a slightly higher intent score of 0.86, which indicates that on a scale of 0 to 1, the classification engine 306 has determined that it is highly likely that both these example texts have a help-seeking intent.

The classification engine 306 arrives at the output by identifying, extracting, quantifying, and studying effective states and subjective information in textual data using natural language processing, text analysis, and computation linguistics.

In some embodiments, the classification engine 306 utilizes a machine-learning (ML) model for the classification. An ML model that performs a classification task is often called a ‘classifier’ and there are a number of different classifiers that use different classification algorithms to train their ML model to perform the classification. These different classifiers have different advantages and disadvantages that may vary depending on a given classification task.

Further, there are two main approaches to train a classifier—supervised and unsupervised learning. In supervised ML, a classifier learns to predict the correct class label using training data that has previously been classified. For example, to train the classifier to classify input text as help-seeking or not, thousands if not hundreds of thousands of sentences labelled as ‘help-seeking’ or ‘not help-seeking’ are fed to the classifier. In this case, the classifier learns to classify new sentences in either one of these categories based on patterns it has learnt from the previously seen labelled sentences. For instance, it may identify similarities between the sentences labelled as ‘helps-seeking’, such as certain word clusters, certain tones, certain sentence structures or length of sentences, etc., and determine certain features or patterns to look for in a sentence to determine whether it is help-seeking or not. In unsupervised ML, on the other hand, the training data is not pre-classified or tagged and there is no guide to a desired output. Instead, in this type of learning, the classifier identifies hidden patterns or data groupings in the training data without human intervention. It may form two different data groups—‘help-seeking and ‘not help-seeking’ and then try to cluster new sentences in one of these groups based on identification of one or more patterns in the sentences.

Some classifiers use artificial neural networks (ANN) or convolutional neural networks (CNN). An ANN or CNN consists of interconnected nodes or neurons in a layered structure that resembles the human brain. The interconnected nodes create an adaptive, feedback system in which computers learn from their mistakes and improve continuously.

In order to do so, each neuron produces an output after receiving one or more inputs. These outputs are then passed to the next layer of neurons, which use these outputs as inputs for their own function, and produce further outputs. These outputs are then passed on to the next layer of neurons, and so on until every layer of neurons have been considered, and the terminal neurons (e.g., the final layer of neurons) have received their input. The terminal neurons then output the final result for the model.

Training a CNN essentially means selecting one model from a set of allowed models that minimizes a cost criterion. There are numerous algorithms available for training neural network models; most of them can be viewed as a straightforward application of optimization theory and statistical estimation.

In the present disclosure, the classification engine 306 includes a language representation model that is trained from copious amounts of unlabeled text to determine not only the meaning of words, but also their meaning based on context. For example, the language representation model is a bidirectional model that identifies the meaning of words based on their context in a complete sentence. For example, the language representation model can determine that the word ‘bank’ has two different meanings in the terms ‘bank deposit’ and ‘river bank’. Further, the model understands the relationships between sentences. In one example, the language representation model may be the Bidirectional Encoder Representations from Transformers model (BERT model).

Once the language representation model is trained to determine the context of words and relationships between sentences, it is fine-tuned to determine the difference between help-seeking and non-help-seeking intent in sentences or portions of text. During the fine-tuning, the pre-trained parameters of the models are fine-tuned using labelled data.

In particular, the model is trained on a dataset of previously created customer support tickets and social media activities that are labelled as having help-seeking intent or no-help-seeking intent. Textual data from historical customer support tickets is labelled as having help-seeking intent. Textual data from social media activities is labelled as having help-seeking intent or not (depending on the actual intent). The model is then fine-tuned on copious amounts of such labelled textual data to help the model fine-tune its weights to accurately determine whether a sentence or set of sentences were associated with a help-seeking intent or not. Then, the model is provided unlabeled test data. During the testing phase, test data is fed to the classification engine 306 and based on the weights of the networks, it classifies the textual data as help-seeking or not and assigns a help-seeking intent score indicating the extent of help-seeking intent detected in the textual data. If the assigned label and/or intent score is incorrect, the parameters or weights of the model may be adjusted to produce the correct output. This process is repeated numerous times with large amounts of textual data, until the model can correctly assign the right labels and intent scores most of the times. It will be appreciated that the more the process is repeated, the more accurate the classification model may be.

The ticket generation module 308 is configured to generate tickets if the classification engine 306 determines that a social media message is associated with a help-seeking intent.

The ITS interface 310 is configured to communicate any tickets generated by the ticket generation module 308 to the ITS 220.

The bot 312 is configured to monitor the one or more tickets communicated to the ITS 220 and receive updates on the ticket, e.g., agent comment. The bot 312 is also configured to communicate these updates to the corresponding social media platform 210 from which the social media message was retrieved that resulted in the ticket being generated. The social media platform 210 may, in response, display the received message in response to the original message posted by the user. Thereafter, if the user makes a comment on that message on the social media platform, it may be received by the bot 312 and communicated to the ITS 220. This way, the bot 312 provides two-way communication and integration between a particular social media message and an ITS ticket.

The database 314 stores content items, content item descriptors, ticket data, and any other data required by the issue management system to function, such as social media data corresponding to an ITS ticket and vice versa.

As illustrated in FIG. 2, communications between the various systems 210-230 are via the communication network 240. The communication network 240 is depicted as a single network in FIG. 2 for ease of depiction. However, in actual implementation, the various systems illustrated in FIG. 2 may communicate with other systems over different communication networks. For example, the issue management system 230 may communicate with the ITS 220 through a local area network (LAN), whereas it may communicate with the social media platforms 210 via a public network (e.g., the Internet).

While single server architecture has been described herein, it will be appreciated that the ITS 220 and issue management system 230 can be implemented using alternative architectures. For example, in certain cases a clustered architecture may be used where multiple server computing instances (or nodes) are instantiated to meet system demand Conversely, in the case of small enterprises with relatively simple requirements the ITS 220 and/or issue management system 230 may be a stand-alone implementation (e.g., single server computers) directly accessed/used by the end user).

It will be appreciated that although the environment 200 shows three social media platforms 210 and one ITS 220, this need not be the case in all implementations. In some implementations fewer or more social media platforms 210 may be interfaced with the issue management system 230. Similarly, in those or other implementations, more than one ITS 220 may be interfaced with the issue management system 230. Further, each of those ITS may service one or more organizations, software applications, or products without departing from the scope of the present disclosure.

Further, although the issue management system 230 is depicted as an independent entity in communication with the ITS 220, this need not be the case in all implementations. In some cases, the issue management system 230 may be part of the ITS 220 and may be implemented by the ITS server 222.

Further still, although the issue management system 230 is depicted with sub-systems 302-314, this need not be the case in all implementations. In some implementations the issue management system 230 may have fewer or more sub-systems or modules without departing from the scope of the present disclosure. In other cases, the issue management system 230 may include additional sub-systems. For instance, in some embodiments, the issue management system 230 may include a sentiment engine that is configured to identify an underlying sentiment from input text data. In such cases, the classification engine 306 may be configured to determine whether a message is help-seeking in nature or not based on the sentiment associated with an input text data along with the content of the message.

The embodiments and features described herein are implemented by one or more special-purpose computing systems or devices. For example, in environment 200 each of the social media platforms 210, the ITS 220 and the issue management system 230 is or includes a type of computing system.

A special-purpose computing system may be hard-wired to perform the relevant operations. Alternatively, a special-purpose computing system may include digital electronic devices such as one or more application-specific integrated circuits (ASICs) or field programmable gate arrays (FPGAs) that are persistently programmed to perform the relevant operations. Further, alternatively, a special-purpose computing system may include one or more general-purpose hardware processors programmed to perform the relevant operations pursuant to program instructions stored in firmware, memory, other storage, or a combination.

A special-purpose computing system may also combine custom hard-wired logic, ASICs, or FPGAs with custom programming to accomplish the relevant operations described herein. A special-purpose computing system may be a desktop computer system, a portable computer system, a handheld device, a networking device or any other device that incorporates hard-wired and/or program logic to implement relevant operations.

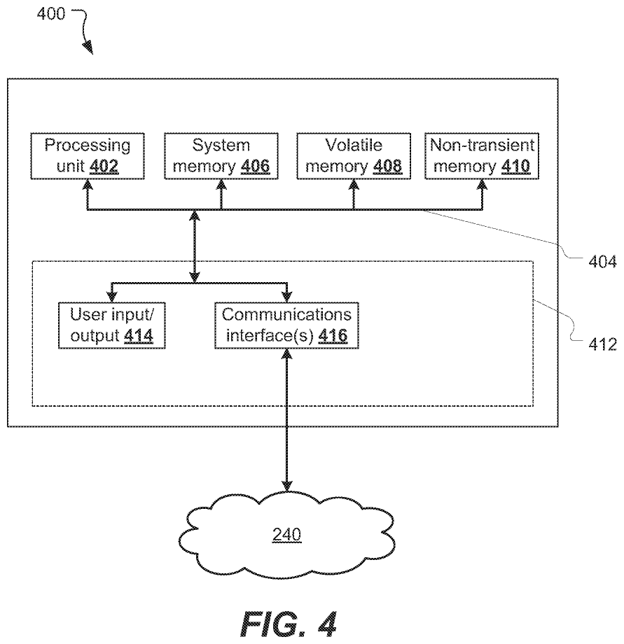

FIG. 4 provides a block diagram of a computer processing system 400 configurable to implement embodiments and/or features described herein. System 400 is a general purpose computer processing system. It will be appreciated that FIG. 4 does not illustrate all functional or physical components of a computer processing system. For example, no power supply or power supply interface has been depicted, however system 400 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 400 includes at least one processing unit 402—for example a general or central processing unit, a graphics processing unit, or an alternative computational device). Computer processing system 400 may include a plurality of computer processing units. In some instances, where a computer processing system 400 is described as performing an operation or function all processing required to perform that operation or function will be performed by processing unit 402. In other instances, processing required to perform that operation or function may also be performed by remote processing devices accessible to and useable by (either in a shared or dedicated manner) system 400.

Through a communications bus 404, processing unit 402 is in data communication with a one or more computer readable storage devices which store instructions and/or data for controlling operation of the processing system 400. In this example system 400 includes a system memory 406 (e.g., a BIOS), volatile memory 408 (e.g., random access memory such as one or more DRAM applications), and non-volatile (or non-transitory) memory 410 (e.g., one or more hard disks, solid state drives, or other non-transitory computer readable media). Such memory devices may also be referred to as computer readable storage media (or a computer readable medium).

System 400 also includes one or more interfaces, indicated generally by 412, via which system 400 interfaces with various devices and/or networks. Generally speaking, other devices may be integral with system 400, or may be separate. Where a device is separate from system 400, connection between the device and system 400 may be via wired or wireless hardware and communication protocols, and may be a direct or an indirect (e.g., networked) connection.

Wired connection with other devices/networks may be by any appropriate standard or proprietary hardware and connectivity protocols, for example Universal Serial Bus (USB), eSATA, Thunderbolt, Ethernet, HDMI, and/or any other wired connection hardware/connectivity protocol.

Wireless connection with other devices/networks may similarly be by any appropriate standard or proprietary hardware and communications protocols, for example infrared, BlueTooth, Wi-Fi; near field communications (NFC); Global System for Mobile Communications (GSM), Enhanced Data GSM Environment (EDGE), long term evolution (LTE), code division multiple access (CDMA—and/or variants thereof), and/or any other wireless hardware/connectivity protocol.

Generally speaking, and depending on the particular system in question, devices to which system 400 connects—whether by wired or wireless means—include one or more input/output devices (indicated generally by input/output device interface 414). Input devices are used to input data into system 400 for processing by the processing unit 402. Output devices allow data to be output by system 400. Example input/output devices are described below; however, it will be appreciated that not all computer processing systems will include all mentioned devices, and that additional and alternative devices to those mentioned may well be used.

For example, system 400 may include or connect to one or more input devices by which information/data is input into (received by) system 400. Such input devices may include keyboards, mice, trackpads (and/or other touch/contact sensing devices, including touch screen displays), microphones, accelerometers, proximity sensors, GPS devices, touch sensors, and/or other input devices. System 400 may also include or connect to one or more output devices controlled by system 400 to output information. Such output devices may include devices such as displays (e.g., cathode ray tube displays, liquid crystal displays, light emitting diode displays, plasma displays, touch screen displays), speakers, vibration applications, light emitting diodes/other lights, and other output devices. System 400 may also include or connect to devices which may act as both input and output devices, for example memory devices/computer readable media (e.g., hard drives, solid state drives, disk drives, compact flash cards, SD cards, and other memory/computer readable media devices) which system 400 can read data from and/or write data to, and touch screen displays which can both display (output) data and receive touch signals (input).

System 400 also includes one or more communications interfaces 416 for communication with a network, such as network 240 of environment 200. Via a communications interface 416 system 400 can communicate data to and receive data from networked devices, which may themselves be other computer processing systems.

System 400 may be any suitable computer processing system, for example, a server computer system, a desktop computer, a laptop computer, a netbook computer, a tablet computing device, a mobile/smart phone, a personal digital assistant, or an alternative computer processing system.

System 400 stores or has access to computer applications (also referred to as software or programs)—for example, computer readable instructions and data which, when executed by the processing unit 402, configure system 400 to receive, process, and output data. Instructions and data can be stored on non-transitory computer readable media accessible to system 400. For example, instructions and data may be stored on non-transitory memory 410. Instructions and data may be transmitted to/received by system 400 via a data signal in a transmission channel enabled (for example) by a wired or wireless network connection over interface such as 412.

Applications accessible to system 400 will typically include an operating system application such as Microsoft Windows™, Apple macOS™, Apple iOS™, Android™ Unix™, or Linux™.

System 400 also stores or has access to applications which, when executed by the processing unit 402, configure system 400 to perform various computer-implemented processing operations described herein. For example, and referring to networked environment 200 of FIG. 2 above, social media platforms 210 include server applications which configure the social media platforms 210 to perform operations of the social media platforms, the issue tracking system 220 includes a server application which configured the issue tracking system 220 to perform operations of issue tracking systems, and issue management system 230 includes a number of subsystems which are executed by one or more processing units 402 which configure the computer processing system(s) to perform the described issue management system operations.

In some cases, part or all of a given computer-implemented method will be performed by a single computer processing system 400, while in other cases processing may be performed by multiple computer processing systems in data communication with each other.

### Example Processes

This section describes a computer-implemented method for automatically generating a ticket according to aspects of the present disclosure.

Generally speaking, social media platforms 210 are not only used by people, but also by organizations to stay connected with their customers. Typically, most entities such as organizations or software products have a social media account that is monitored by one or more employees of the organization, who not only post content on the social media platform on behalf of the organization or software product but also respond to content created by other users in relation to the organization or software product.

To become a user of a social media, a person is typically required to create a user account for the person or organization/product. A user account is typically associated with one or more information items specific to a user such as entity name, public name or alias, business location, industry, etc. This account information may be added as metadata when a user creates content on the social media platforms.

One feature that has become a de facto standard in social media platforms 210 is the ability of a first user to name a second user or entity of the platform within the content created by the first user. In the present embodiment, this feature is referred to as “mention” and “mentioning” (e.g., the first user mentioned the second user/entity). There are several reasons for a first user to mention a second user/entity on a social media platform. For example, the first user may wish to start a conversation with the second user/entity. Social media platforms typically respond to detecting mentions by bringing the event to the attention of the mentioned user/entity in various ways (e.g., by showing a notification message or icon), which enables the mentioned user to respond, if so desired.

When a user of a social media platform 210 creates content through the system (e.g., by writing a text in an editor provided by the social media platform 210 or uploading a photo from their smartphone into the system), the social media platform 210 may associate some additional metadata with the user-created content. For instance, the social media platform 210 may provide the username, profile picture, location information or any other user information held by the social media platform 210.

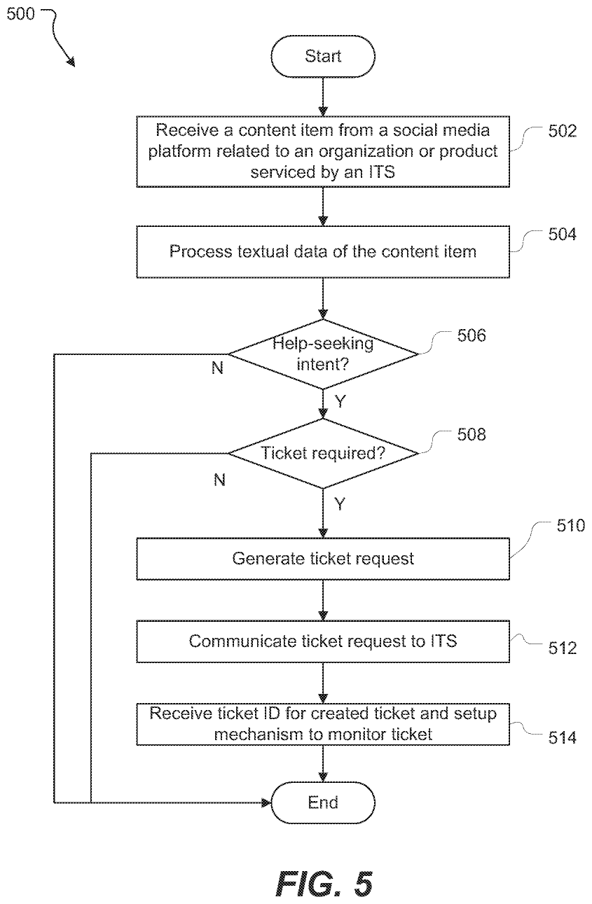

FIG. 5 is a flowchart illustrating an example method 500 performed by the issue management system 230 to generate one or more tickets. In some embodiments, method 500 is performed periodically, e.g., every 10 minutes. In other examples, the method 500 is continuously performed in real-time whenever a new social media message is received at the gateway module 302. FIG. 5 illustrates one cycle of this method. Further, although the issue management system 230 may service multiple ITS 220 and each ITS may service multiple entities, for ease of description, it is assumed that the issue management system 230 services one ITS 220 that provides a helpdesk for one organization, e.g., ABC company.

Furthermore, in the method 500, wherever the term “content item” or “content items” is used, it is meant to encompass any posts, messages, tweets, comments or any other type of content created on a social media platform 210 that were either posted on the account of the software application or organization serviced by the ITS 220, “mentioned” one or more of those accounts, or included the name of the software application or organization.

The method 500 commences at step 502, where the SM gateway module 302 receives a content item from one of the social media platforms (e.g., from social media platform 210A) that is related to company ABC. In one example, the content item is a tweet that mentions the company ABC. In addition to the actual content item, the gateway module 302 may also receive metadata information associated with the content item (e.g., name of the user associated with the content item, user location, etc.).

In some embodiments, the SM gateway module 302 may be configured to pull the content item from the social media platforms 210 in real time, e.g., by utilizing web-hooks (programmed into the software applications and tools hosted by the social media platforms 210) that notify the gateway module 302 when a content item associated with company ABC is created on the social media platforms 210. In other cases, it may pull content items periodically by requesting the social media platforms 210 at predetermined intervals (e.g., every 10 minutes, every 30 minutes, etc.) to provide content items that were generated in that interval and include the company name ABC in the content, mention the name or were posted on company ABCs social media account.

In other embodiments, the social media platforms 210 may push content items to the gateway module 302 either in real time (e.g., whenever a content item is generated) or at predetermined intervals (e.g., every 10 minutes, every 30 minutes, etc.).

The gateway module 302 is configured to inspect the received content item and discard the content item if it does not have any textual data or content. For example, if the content item only includes multimedia such as images, videos, audio files, etc., it may be discarded. Otherwise, if the content item includes textual data, the gateway module 302 is configured to generate a content item descriptor. The descriptor may include the textual content from the content item and metadata about the content item such as time of creation, location information, creator, etc.

If the ITS 220 services more than one organization or software application, the gateway module 302 may also store information about the software application or organization the content item is related to. Table A illustrates an example content item descriptor. Although a table has been used to illustrate the information stored in the content item descriptor, the relevant information need not be entered in a table and could be stored in any appropriate format (e.g., simple text file, a JSON file, an XML file, etc.).

TABLE A
example content item descriptor

| | |
|---|---|
| Content item ID | 834739 |
| Time created | 23 April 2022, 11:05pm |
| Social media Platform ID | Platform 110A |
| Social media content ID | acfde327462ad5f |
| Software application | Jira Align |
| User | Jane Doe |
| Content | “This is unbelievable, my computer |
| | just crashed, while I was giving a |
| | presentation! This is the second time |
| | this has happened this week. Also, I |
| | was in the middle of the best part!” |
| Segments | — |
| Segment IDs | — |
| Classification label | — |
| Intent score | — |

As seen in table A, the content item descriptor includes some fields that are populated by the gateway module 302 upon receiving the content items and includes other fields that are not populated by the gateway module 302. These fields are updated by other modules in the issue management system 230 as the method proceeds. Once created, the content item descriptors may be stored in the database 218 or passed on to the featurization module 304.

Next, at step 504, the textual data of the content items is processed. This may include segmenting larger messages into smaller segments. In one example, textual data containing several sentences is split into smaller segments, including fewer sentences, e.g., 2-3 sentences. This segmenting of larger messages improves the performance of the classification engine 134 because sentiments of help seeking nature generally do not span more than a few sentences. Furthermore, smaller data segments help maintain uniformity across training and inference samples and prevent unexpected processing malfunctions.

If the textual data of a content item is segmented, the featurization module 304 updates the content item descriptor to update the segments field and the segment identifiers field. In addition, it may create segment descriptors for each of the segments that include unique identifiers of the segments, the identifier of the parent content item descriptors and fields for including the sentiment label and sentiment score for the segment. An example of a segment descriptor is illustrated below.

TABLE B
Example segment descriptor

| | |
|---|---|
| Segment ID | 1 |
| Parent Content item ID | 834739 |
| Content | “This is unbelievable, my computer |
| | just crashed, while I was giving a |
| | presentation! This is the second time |
| | this has happened this week.” |
| Classification label | — |
| Intent score | — |

As seen in table B, the segment descriptor includes an identifier of the segment and the parent content item, and the actual textual data of the segment. These fields may be populated by the featurization module 304. The segment descriptor includes other fields as well that are not populated by the featurization module 304. These fields are updated by the sentiment analysis engine 208 as the method proceeds.

Once it is determined whether the textual data for a content item needs to be segmented or not, the featurization module 304 can process the segmented or un-segmented textual data. For example, the featurization module 304 may clean the textual data to remove any elements that do not contribute to the sentiment of the message. These elements may include punctuations, articles, links, URLs, etc. It can also stem certain words in the textual data to produce morphological variants of a root or base word. By way of example, the process of stemming identifies words such as “chocolates,” “chocolatey,” and “choco” that are morphological variants of chocolate and replaces them with the root word “chocolate.” Another example would be to substitute words such as “retrieval,” “retrieved,” and “retrieves” with the root word “retrieve.” The featurization module 304 may also analyze the textual data to group together different inflected forms of a word so they can be analyzed as a single item. This process is commonly known as lemmatization. By way of example, the process of lemmatization can replace the words “better” with “good.” This process essentially transforms various words to an equivalent base form in order to further reduce the total number of words that must be processed by the system in the next stages.

At the end of step 504, the corresponding content item descriptor or segment descriptor may be updated. In particular, the textual data in the content field may be replaced by the processed textual data and the segments and segment identifier fields may be updated if the textual data has been segmented. In other examples, the content item descriptor may include a separate field for the processed textual data and the featurization module 304 updates that field. Table C illustrates an example content item descriptor after step 504.

TABLE C
Content item descriptor after step 504

| | |
|---|---|
| Content item ID | 834739 |
| Time created | 23 April 2022, 11:05pm |
| Social media Platform ID | Platform 110A |
| Social media content ID | acfde327462ad5f |
| Software application | Jira Align |
| User | Jane Doe |
| Location data | Sydney, Australia |
| Content | “unbelievable my computer crashed |
| | again happened second time this |
| | week also I was in middle of best |
| | part” |
| Segments | 2 |
| Segment IDs | 1, 2 |
| Classification label | — |
| Intent score | — |

At step 506, the classification engine 306 determines whether the textual data of the content item indicates a help-seeking intent or not. In particular, the classification engine 306 determines a help-seeking intent score. A score between 0 and 0.4 may indicate no help-seeking intent whereas a score between 0.4-1 may indicate some level of help-seeking intent.

As described previously, the classification engine 306 is trained and fine-tuned to make this determination. Accordingly, at step 506, the classification engine 306 receives the content item descriptor from the featurization module 304, retrieves the ‘content’ from the descriptor and determines whether the content has any help-seeking intent and assigns a help-seeking intent score to the content. It then updates the classification label and intent score fields of the content item descriptor.

If any of the content items were segmented, the classification labels and intent scores associated with segments are aggregated and the segment descriptors are deleted. Classification labels and intent scores usually represent social media user intents determined for various segments of a message and not for the entirety of the message. Aggregating classification labels and intent scores reveals the overall intent associated with the entire message.

To do so, the classification engine 306, retrieves the segment descriptors associated with a given content descriptor (e.g., by performing a lookup for the segment identifiers associated with the content item identifier), retrieves the classification labels and intent scores from the segments and aggregates them. In one example aggregation includes calculating an average score for the classification labels based on the individual intent scores and number of segments. In other examples, mean or median values may be computed. In still other examples, aggregation may include summing the individual intent scores. Once the intent scores from the segments are aggregated, the content item descriptor may be updated with the aggregated classification labels and intent scores and the corresponding segment descriptors may be deleted. The classification engine 306 then passes the descriptor to the ticket generation module 308.

Table D illustrates an example content item descriptor after step 506.

TABLE D
Example content item descriptor after step 506

| | |
|---|---|
| Content item ID | 834739 |
| Time created | 23 April 2022, 11:05pm |
| Social media Platform ID | Platform 110A |
| Social media content ID | acfde327462ad5f |
| Software application | Jira Align |
| User | Jane Doe |
| Location data | Sydney, Australia |
| Content | “This is unbelievable, my computer just |
| | crashed, while I was giving a |
| | presentation! This is the second time |
| | this has happened this week. Also, I |
| | was in the middle of the best part!”” |
| Classification label | Help-seeking |
| Intent score | 0.73212321382 |

At step 508, the ticket generation module 308 determines whether a ticket needs to be generated. In one example, this decision may be based on the classification label and intent score determined by the classification engine 306. In particular, it may be based on a comparison of the intent score with a threshold score. If the classification label indicates that the content item has a help-seeking intent and the intent score is higher than the threshold score, e.g., 0.66, the ticket generation module 308 may determine that the ticket needs to be generated. Alternatively, if the classification label indicates that the content item does not have a help-seeking intent or the intent score is lower than a threshold score, e.g., 0.66, the ticket generation system 208 determines that a ticket is not required.

If at step 508, a determination is made that a ticket is not required, the content item descriptor may be discarded and the method 500 ends. Alternatively, if at step 508, a determination is made that a ticket is required, the method proceeds to step 510, where the ticket generation module 308 generates a request for a ticket. The request may include, e.g., a title and description for the ticket and information about the user associated with the ticket. In some examples, the ticket generation module 308 generates a title for the ticket based on the original content of the message and may add user information from the user field in the content item descriptor.

At step 512, the ticket generation module 308 communicates the ticket request the ITS interface 310. It also stores the ticket request as a ticket descriptor in the database 314 in association with the corresponding content item descriptor. Table E illustrates an example ticket descriptor that may be stored in the database 314 at this step. In addition to the ticket title and summary, the ticket descriptor includes the identifier of the corresponding content item descriptor and includes a field to store the ticket identifier generated by the ITS 220. The ticket descriptor also includes a status field that indicates the current status of the ticket, such as open, closed, in progress, etc., a ITS comment field that includes the comments received from the ITS 220 on that particular ticket along with date/timestamps and an SM comment field that includes the comments received from the social media platform on that particular ticket.

TABLE E
Example ticket descriptor

| | |
|---|---|
| Ticket Identifier | — |
| Content item ID | 834739 |
| Title | Laptop crashed |
| Description | “This is unbelievable, my computer just |
| | crashed, while I was giving a |
| | presentation! This is the second time this |
| | has happened this week. Also, I was in |
| | the middle of the best part!” |
| Status | — |
| ITS comments | — |
| SM comments | — |

At step 512, the ITS interface 310 communicates the ticket request to the ITS 220. In particular, the ITS interface requests the ITS 220 to create a ticket based on the information provided in the ticket request. An example of this request in provided in table F below—

TABLE F
Example ticket request

```
function createTicket (serviceDeskClient, TicketId) {
  const requestPayload = {
    title: ‘Jira cloud crashed’,
    description: ‘This is unbelievable, my computer just crashed,
while I was giving a presentation! This is the second time this has
happened this week. Also, I was in the middle of the best part’
  };
  return serviceDeskClient.createRequest(TicketId, requestPayload);
}
```

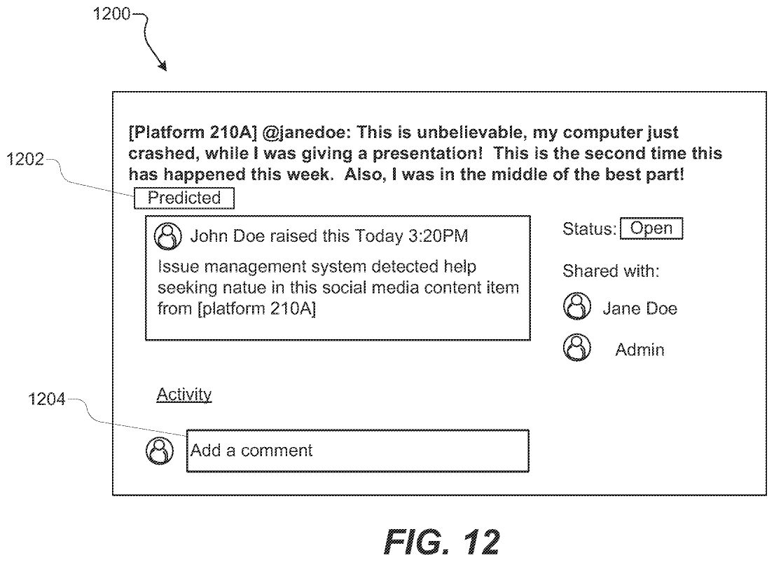

FIG. 12 depicts an example ticket 1200 that may be created by the ITS upon receiving the ticket request. As seen in FIG. 12, the title of the ticket includes the source social media platform identifier, user handle of the user that created the content item and at least a portion of the original message. The ticket also includes indicator 1202 that indicates that the ticket had been generated based on a prediction. Further, the details about the ticket indicate that the ticket had been created by the issue management system 230 based on identification of help-seeking intent in a corresponding content item.

At step 514, if the ITS 220 is able to create the ticket successfully, the ITS interface 310 receives the ticket identifier for the created ticket and a status of the ticket. It may then update the ticket descriptor and in particular the ticket identifier and status fields based on the received data.

At this step, the bot 312 may also set up a mechanism to monitor the status of the ticket. In some embodiments, it may setup a webhook for the ticket—e.g., an automated message sent from the ITS 220 to the issue management system 230 whenever something happens to the ticket on the ITS 220—e.g., a status has changed, an agent is assigned to the ticket, an agent has made a comment, etc. In some cases, the bot 312 may request the ITS 220 to send an automated message only when certain types of actions occur on the ticket—such as change in status or a new comment from an agent. In this case, the ITS 220 only sends messages to the issue management system 230 when the corresponding types of actions occur and does not send messages when any other types of actions happen on the ticket.

In some embodiments, instead of setting up a webhook, the ITS interface 310 may decide to poll the ITS 220 periodically to determine whether there is an update on the ticket. If this is preferred, the ITS interface 310 may setup a task for polling the ITS for updates on this ticket based on a predetermined frequency. In other examples, it may poll the ITS 220 for a plurality of tickets at the same time. In such examples, the ITS interface 310 may add the ticket identifier to the list of tickets to poll for.

Optionally, once a ticket has been generated at the ITS 220, the issue management system 230 may communicate information about the ticket that has been created to the social media platform 210 from which the original content item was retrieved. The social media platform can post a comment or communication in response to the original content item on the social media platform to inform the user.

In one example, the ITS interface 310 may retrieve the content item identifier from the ticket descriptor, retrieve the content item descriptor based on the identifier and retrieve information about the social media platform from the content item descriptor. For example, it may retrieve the values of social media platform identifier and the social media content identifier to determine which social media platform the content item was received from and to determine the identifier of the content item used by that social media platform. It may then communicate a POST request to the identified social media platform to post a notification in response to the identified social media content item. The notification may include, e.g., “Thank you for your message. We have generated a ticket based on your message. A helpdesk agent will get in touch with you shortly to address your concern. If you do not wish for any assistance at this time, please select the “assistance not required” button below.” Upon receiving the request, the server of the corresponding social media platform may post the notification in association with the original message posted by the user—e.g., as a comment.

The user may view this message and know that the organization is taking steps to address the user's concerns. In addition to the text, the notification may include an interactive affordance or a link, that when selected indicates that the user does not require any assistance at that time. The user may select this affordance or link in case the user does not require assistance any longer or if the ticket generation system erroneously generated a ticket when it was not required. If the user selects the interactive button or link, the bot 312 receives a message from the social media platform. The bot 312 may then request the ITS to delete the corresponding ticket and may itself discard the ticket descriptor and corresponding content item descriptor from the database 216.

In another example, instead of the user determining whether help is required or not, this decision can be made by a helpdesk agent upon reviewing the ticket. For example, the helpdesk agent may view ticket 1200 and from the title and/or description attempt to determine whether a ticket should have been raised for the issue or not. If the agent determines that the ticket is valid, e.g., because the title and/or description do indicate that the social media user may require help, the helpdesk agent may change the status of the ticket, accept the ticket, or create a message using the text editor bar 1204. Otherwise, if the agent determines that the ticket is invalid, e.g., because the title/description do not indicate that the social media user may require help, the agent may close or delete the ticket. In case the user closes the ticket, the social media user may remain unaware that a ticket was every raised. Alternatively, if the agent accepts the ticket, in some embodiments, the social media user may be made aware of the ticket. To this end, when the helpdesk agent changes the status of the ticket, the monitoring issue management system 230 determines that the ticket has been accepted and communicates a message to the corresponding social media platform 210A. The social media platform 210A in turn may post this message in response to the original user post. The message may indicate that a ticket has been raised with the helpdesk and that an agent may get in touch with the user via the social media platform 210A.

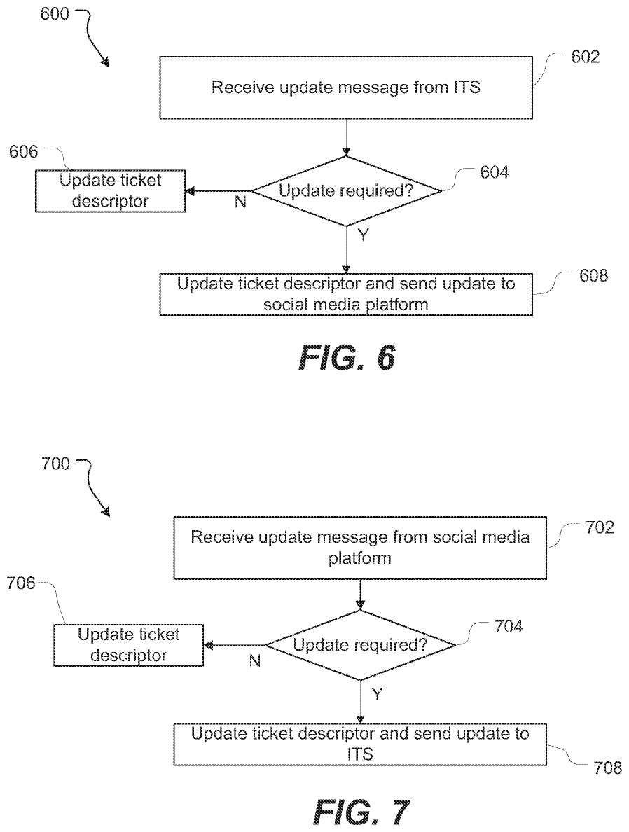

FIGS. 6 and 7 are flowcharts illustrating example methods 600, 700 for integrating a social media message and an ITS ticket according to aspects of the present disclosure. In particular, FIG. 6 shows a method for replicating communication made in the ITS 220 on the social media platform and FIG. 7 shows a method for replicating communication made in the social media platform on the ITS 220. This way, both the help-seeking user and the agent can interact with each other while still remaining in their preferred context or system. That is, the help-seeking user can receive agent updates in the social media platform 210 and the agent can receive the help-seeking user's updates in the ITS 220.

To do this, the issue management system 230 maintains an object for the ticket, e.g., the ticket descriptor that includes the identifier for the ticket used by the ITS 220 and the identifier of the corresponding social media message made by the help-seeking user. Further, the issue management system 230 utilizes mechanisms to receive updates from the ITS 220 in respect of the ticket and from the social media platform 210 in respect of the social media message. For example, it may either poll the ITS and social media platform or use web hooks to automatically receive updates when a message or comment is made in either system with respect to the corresponding ticket or social media message. Armed with the ticket descriptor and the updates from the ITS 220 and social media platform 210, the issue management system 230 can communicate any comment made by the help-seeking user in the social media platform 210 to the ITS 220 and any comment made by an agent in the ITS 220 to the help-seeking user in the social media platform 210.

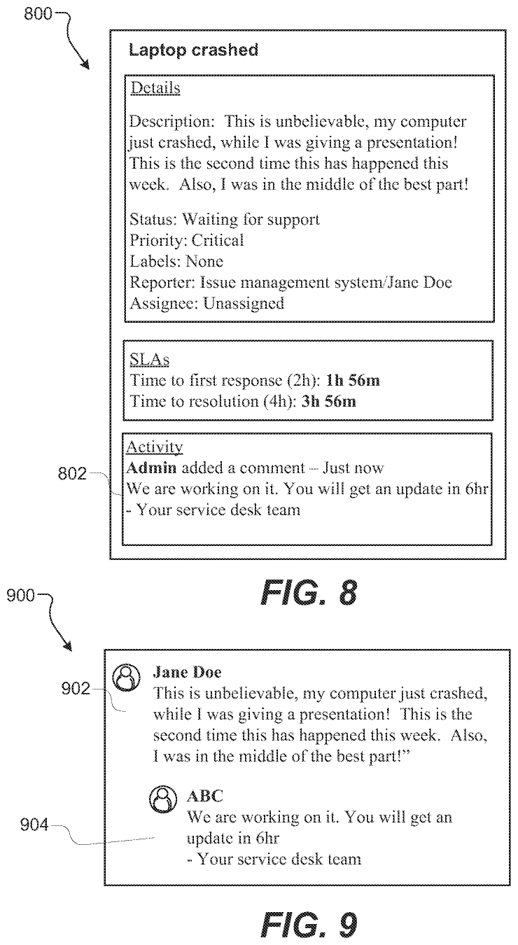

Method 600 commences at step 602, where the issue management system receives a message from the ITS 220 regarding a ticket generated by the issue management system. The message may be received automatically (in case a webhook was employed) or in response to a polling message sent by the bot 312. In any event, the message includes an identifier of the updated ticket and the actual update associated with the ticket. The update may include, e.g., a change in the status of the ticket and/or may include a comment or message entered by an agent on the ticket. FIG. 8 illustrates an updated ticket 800 that includes a new message 802 from an administrator.

At step 604, the bot 312 determines whether an update message has to be communicated to the corresponding social media platform. To this end, the bot 312 determines the nature of the update received at step 602 and whether the update is suitable for transmitting to the corresponding social media platform. In some embodiments, the issue management system 230 may be configured to only transmit comments or messages from the ITS 220 to the social media platform and vice versa. In other embodiments, the issue management system 230 may be configured to transmit any updates to the social media platform, including e.g., status updates, when an agent is assigned to the ticket, etc. Accordingly, at step 604, a determination is made whether the received update is of a type that the issue management system 230 is configured to communicate to the social media platform.

If a determination is made that the update is not of a type that the issue management system 230 is configured to communicate to the social media platform, the method proceeds to step 606, where the bot 312 updates the ticket descriptor based on the update, e.g., updates the status field, and waits for the next update from the ITS.

Alternatively, if a determination is made that the update is of a type that the issue management system 230 is configured to communicate to the social media platform, the method proceeds to step 608, where the bot 312 updates the ticket descriptor based on the update, e.g., updates the agent comment field, and communicates the update to the social media platform. To this end, the bot 312 inspects the social media identifier to identify the social media platform and the social media content identifier to identify the corresponding social media message and generates a POST message to the identified social media platform 210 to post the update, e.g., agent comment, against the identified social media message. FIG. 9 illustrates an example social media message 900 that is updated with the agent comment made in ticket 800. In particular, FIG. 9 shows the help-seeking user's (e.g, Jane Doe's) original message 902 and a response message 904 that is the administrator's comment 802 from ticket 800. The response message 904 is depicted on behalf of the organization or software product serviced by the ITS 120, which in this example is organization ABC.

Thereafter method 600 may be repeated each time the issue management system 230 receives a ticket update from the ITS 220. In some cases, the update message from the ITS 220 may indicate that the ticket has been closed or completed. In such cases as the interface between the social media platform and the ITS is no longer required for that ticket, the bot 312 deletes the corresponding ticket descriptor and content item descriptor. Further, it may discontinue whatever mechanisms it had employed for receiving updates on the ticket and corresponding social media message—e.g., it may cancel any web hooks or stop polling the systems for that particular ticket or social media message.

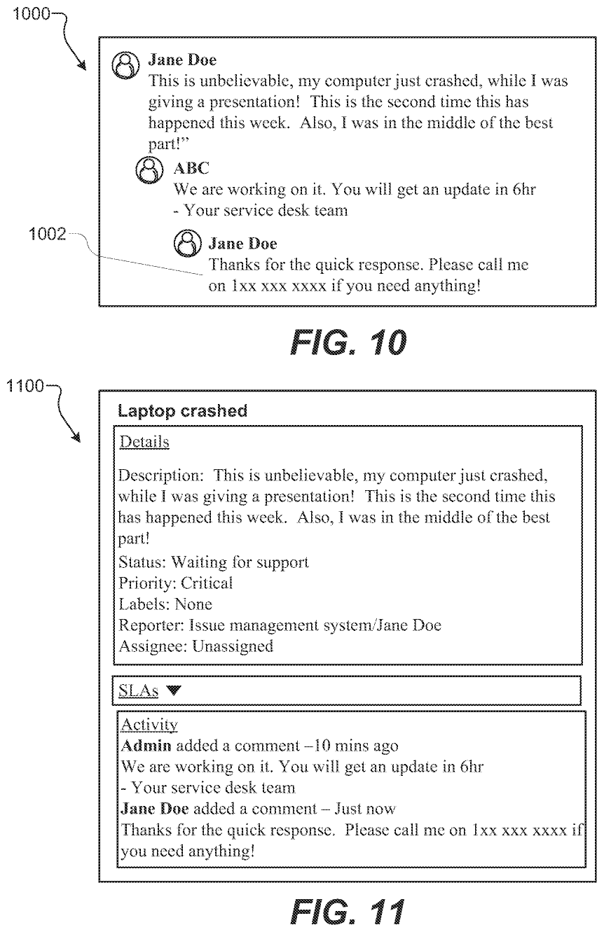

Method 700 commences at step 702, where the issue management system receives a message from a social media platform 210 regarding a social media message the bot 312 was monitoring. In one example, the help-seeking user (Jane Doe) responds to message 904. FIG. 10 depicts the social media message stream including a response 1002 from the help-seeking user. When this response message is posted, the social media platform 210 updates an object for the original message 902 posted by the user. Thereafter, the social media platform 110 may automatically transmit the new message 1002 and corresponding metadata to the bot 312 (in case web hooks are employed) or passes the new message 1002 and corresponding metadata when the bot 312 polls the social media platform 110 for an update. In any event, the update message includes an identifier of the updated social media message along with the actual update and metadata associated with the social media message. In some examples, the update may include, e.g., a message posted by another user, a message posted by the help-seeking user in response to an agent message posted against the social media message, e.g., using method 600, or any other interaction with the social media message, such as a like or share.

At step 704, the bot 312 determines whether an update needs to be transmitted to the corresponding ticket in the ITS 220. To this end, the bot 312 determines the nature of the update received at step 702 and whether the update is suitable for transmitting to the ITS 220. For instance, it determines whether the update is a comment or message from the help-seeking user or any other type of interaction or comment from another user.

If a determination is made that the update is not a comment or message from the help-seeking user, the method proceeds to step 706, where the bot 312 discards the update and waits for the next update from the social media platform.

Alternatively, if a determination is made that the update is a comment or message from the help-seeking user, the method proceeds to step 708 where the bot 312 updates the ticket descriptor based on the update, e.g., updates the help-seeking user comment field, and communicates the update to the ITS 220. To this end, the bot 312 inspects the ticket ID value in the ticket descriptor and generates a POST message using the identified ticket ID and the message from the help-seeking user. FIG. 11 illustrates an example ticket 1100 that is updated with the help-seeking user's comment 1002 made in a social media platform.

Thereafter method 700 may be repeated each time the issue management system 230 receives an update from the social media platform.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including,” “includes,” “comprising,” “comprises,” “comprised,” and the like) are used inclusively and do not exclude further features, components, integers, steps, or elements.

Although the present disclosure uses terms “first,” “second,” etc. to describe various elements, these terms are used only to distinguish elements from one another and not in an ordinal sense.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

What is claimed is:

1. A computer-implemented method, comprising:
retrieving a content item created at a social media platform in relation to an entity being serviced by an issue tracking system;
determining a help-seeking intent associated with the content item based on textual data of the content item;
determining whether the help-seeking intent associated with the content item exceeds a threshold level of intent; and
upon determining that the help-seeking intent associated with the content item exceeds the threshold level of intent:
generating a ticket request based on the textual data of the content item; and
communicating the ticket request to the issue tracking system.

2. The computer-implemented method of claim 1, wherein:
the determining the help-seeking intent comprises determining a help-seeking intent score; and
the determining whether the help-seeking intent associated with the content item exceeds a threshold level of intent comprises comparing the help-seeking intent score with a threshold score.

3. The computer-implemented method of claim 1, further comprising:
receiving a ticket identifier of a ticket generated by the issue tracking system in response to the ticket request; and
storing the ticket identifier along with a social media platform content identifier of the content item.

4. The computer-implemented method of claim 3, further comprising monitoring a status of the ticket generated by the issue tracking system.

5. The computer-implemented method of claim 4, further comprising:
receiving an update message from the issue tracking system, the update message comprising the ticket identifier and a corresponding update;
determining whether an update message has to be communicated to the social media platform based on the update;
upon determining that the update message has to be communicated to the social media platform:
retrieving, the social media platform content identifier based on the ticket identifier; and
communicating the update message to the social media platform along with the social media platform content identifier to cause the social media platform to display the update message in relation to the content item.

6. The computer-implemented method of claim 4, further comprising:
receiving an update message from the social media platform, the update message comprising the social media platform content identifier and a corresponding update;
determining whether the update message has to be communicated to the issue tracking system based on the update;
upon determining that the update message has to be communicated to the issue tracking system:
retrieving the ticket identifier based on the social media platform content identifier; and
communicating the update message to the issue tracking system along with the ticket identifier to cause the issue tracking system to display the update message in relation to the ticket.

7. The computer-implemented method of claim 1, further comprising:
in accordance with the textual data of the content item including more than a threshold number of sentences, segmenting the content item into two or more segments before determining the help-seeking intent;
determining help-seeking intent for each segment of the content item individually; and
aggregating the help-seeking intent for each segment of the content item to determine the help-seeking intent of the content item.

8. A computer processing system for generating ticket requests, comprising:
a processing unit;
non-transitory computer readable medium comprising instructions, which when executed by the processing unit, cause the computer processing system to perform operations comprising:
retrieving a content item created at a social media platform in relation to an entity being serviced by an issue tracking system;
determining a help-seeking intent associated with the content item based on textual data of the content item;
determining whether the help-seeking intent associated with the content item exceeds a threshold level of intent; and
upon determining that the help-seeking intent associated with the content item exceeds the threshold level of intent:
generating a ticket request based on the textual data of the content item; and
communicating the ticket request to the issue tracking system.

9. The computer processing system of claim 8, wherein:
the determining the help-seeking intent comprises determining a help-seeking intent score; and
the determining whether the help-seeking intent associated with the content item exceeds a threshold level of intent comprises comparing the help-seeking intent score with a threshold score.

10. The computer processing system of claim 8, wherein the operations further comprise:
receiving a ticket identifier of a ticket generated by the issue tracking system in response to the ticket request; and
storing the ticket identifier along with a social media platform content identifier of the content item.

11. The computer processing system of claim 10, wherein the operations further comprise monitoring a status of the ticket generated by the issue tracking system.

12. The computer processing system of claim 11, wherein the operations further comprise:
receiving an update message from the issue tracking system, the update message comprising the ticket identifier and a corresponding update;
determining whether the update message has to be communicated to the social media platform based on the update message;
upon determining that the update message has to be communicated to the social media platform:
retrieving the social media platform content identifier based on the ticket identifier; and
communicating the update message to the social media platform along with the social media platform content identifier to cause the social media platform to display the update message in relation to the content item.

13. The computer processing system of claim 11, wherein the operations further comprise:
receiving an update message from the social media platform, the update message comprising the social media platform content identifier and a corresponding update;
determining whether the update message has to be communicated to the issue tracking system based on the update message;
upon determining that the update message has to be communicated to the issue tracking system:
retrieving the ticket identifier based on the social media platform content identifier; and
communicating the update message to the issue tracking system along with the ticket identifier to cause the issue tracking system to display the update message in relation to the ticket.

14. A non-transitory computer readable medium comprising instructions which, when executed by a processing unit, cause the processing unit to perform operations comprising:
retrieving a content item created at a social media platform in relation to an entity being serviced by an issue tracking system;
determining a help-seeking intent associated with the content item based on textual data of the content item;
determining whether the help-seeking intent associated with the content item exceeds a threshold level of intent; and
upon determining that the help-seeking intent associated with the content item exceeds the threshold level of intent:
generating a ticket request based on the textual data of the content item; and
communicating the ticket request to the issue tracking system.

15. The non-transitory computer readable medium of claim 14, wherein:
the determining the help-seeking intent comprises determining a help-seeking intent score; and
the determining whether the help-seeking intent associated with the content item exceeds a threshold level of intent comprises comparing the help-seeking intent score with a threshold score.

16. The non-transitory computer readable medium of claim 14, wherein the operations further comprise:
receiving a ticket identifier of a ticket generated by the issue tracking system in response to the ticket request; and
storing the ticket identifier along with a social media platform content identifier of the content item.

17. The non-transitory computer readable medium of claim 16, wherein the operations further comprise monitoring a status of the ticket generated by the issue tracking system.

18. The non-transitory computer readable medium of claim 17, wherein the operations further comprise:
receiving an update message from the issue tracking system, the update message comprising the ticket identifier and a corresponding update;
determining whether the update message has to be communicated to the social media platform based on the update;
upon determining that the update message has to be communicated to the social media platform:
retrieving, the social media platform content identifier based on the ticket identifier; and
communicating the update message to the social media platform along with the social media platform content identifier to cause the social media platform to display the update message in relation to the content item.

19. The non-transitory computer readable medium of claim 17, wherein the operations further comprise:
receiving an update message from the social media platform, the update message comprising the social media platform content identifier and a corresponding update;
determining whether the update message has to be communicated to the issue tracking system based on the update;
upon determining that the update message has to be communicated to the issue tracking system:
retrieving the ticket identifier based on the social media platform content identifier; and
communicating the update message to the issue tracking system along with the ticket identifier to cause the issue tracking system to display the update message in relation to the ticket.

20. The non-transitory computer readable medium of claim 14, wherein the operations further comprise:
in accordance with the textual data of the content item including more than a threshold number of sentences, segmenting the content item into two or more segments before determining the help-seeking intent;
determining help-seeking intent for each segment of the content item individually; and
aggregating the help-seeking intent for each segment of the content item to determine the help-seeking intent of the content item.
